(19) United States
(12) Patent Application Publication
(10) Pub. No.: US 2004/0044469 A1
(43) Pub. Date: Mar. 4, 2004

(54) Displaying road maps

(76) Inventors: Thorsten Bender, Ludwigshafen (DE); Christian Stelling, Riegelsberg (DE); Philipp Hassler, Leimen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/307,268

(22) Filed: Nov. 27, 2002

Related U.S. Application Data
(60) Provisional application No. 60/408,090, filed on Sep. 3, 2002.

(51) Int. Cl. G01C 21/32

(52) U.S. Cl. 701/208; 340/995.1

(57) ABSTRACT

Displaying a road map in a transportation planning computer program includes receiving data for the road map, rendering the road map from the data, augmenting the road map with landmark information, and toggling between a route view of the road map and a symbolic view of the road map. The route view displays a driving route between two locations on the road map. The symbolic view displays straight lines between locations on the road map.

### TECHNICAL FIELD

This application relates generally to displaying road maps in a computer program, such as a transportation planning application for use in supply chain management.

### BACKGROUND

Many different types of geographic services exist. These services use “geo-servers”, which include computer hardware and/or software that provide geographic information.

In operation, a geo-server receives input geographic information and provides output geographic information in response to the input geographic information. For example, a geo-server may translate addresses received from an external computer system to geographic coordinates, such as longitudes and latitudes (referred to as “geocoding”). The geo-server may also provide the external computer system with a map that shows routes between the addresses.

### SUMMARY

In general, in one aspect, the invention is directed to a method of displaying a road map in a transportation planning computer program. The method includes receiving data for the road map, rendering the road map from the data, augmenting the road map with landmark information, and toggling between a route view of the road map and a symbolic view of the road map. The route view displays a driving route between two locations on the road map. The symbolic view displays straight lines between locations on the road map. This aspect may also include one or more of the following features.

The road map may include target locations and expected stop-over locations between the target locations. The target locations may be customer locations. The landmark information may include points of interest along a route between two or more target locations. For example, the landmark information may include one or more of a gas station along the route, a location of a restaurant along the route, and a location of construction along the route, or other such features.

The method may include displaying at least one of distance and travel time for a selected route on the road map, selecting a shipment associated with the transportation planning computer program, and requesting data for a road map associated with the selected shipment. The data for the road map may include data associated with the selected shipment. The method may include requesting the data from a geocoding service and receiving the data from the service. The data may be routed via a server that provides a generic interface to servers associated with plural geocoding services.

In other aspects, the invention is directed to an apparatus and machine-readable medium containing instructions that are used in performing the foregoing method.

In general, in another aspect, the invention is directed to a graphical user interface (GUI) for a transportation planning computer program. The GUI includes a window to display a road map that defines target locations, a route between the target locations, and a landmark along the route, and a list of shipment options, at least one of the shipment options corresponding to the road map. This aspect may also include one or more of the following features.

The GUI may include a first field to display a travel time between the target locations and a second field to display a distance between the target locations. The GUI may include a button for toggling between a route view of the road map and a symbolic view of the road map. The route view may display a driving route between two locations on the road map. The symbolic view may display straight lines between locations on the road map. Zoom-in and zoom-out controls for increasing or decreasing the size of the road map may also be included.

Other features and advantages of the invention will become apparent from the following description, including the claims and drawings.

### DESCRIPTION OF THE DRAWINGS

FIG. 1 is a block diagram of a network containing an Internet graphics server.

FIG. 2 is a block diagram of the software architecture of the Internet graphics server.

FIG. 3 is a flowchart showing a process for providing data to the Internet graphics server.

FIG. 4 is a flowchart showing a process performed by the Internet graphics server for providing a generic interface to plural geo-servers.

FIG. 5 is a flowchart showing a process performed by a transportation planning application for rendering road maps provided by the Internet graphics server.

FIG. 6 is a graphical user interface for displaying the road maps.

### DESCRIPTION

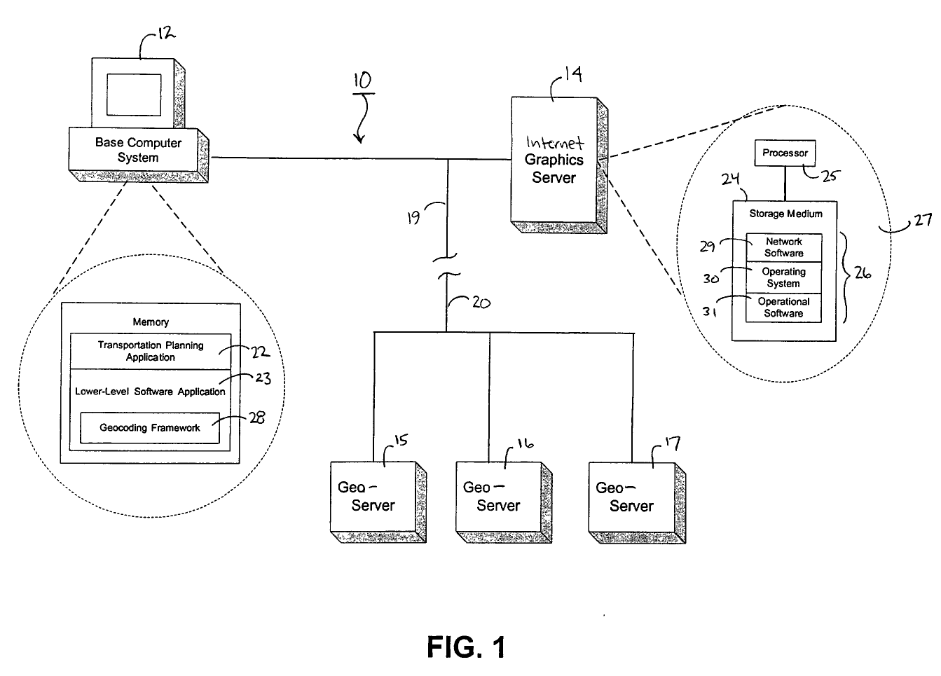

Referring to FIG. 1, a network 10 includes a base computer system 12, an Internet graphics server (IGS) 14, and multiple geo-servers 15, 16, 17. Connections between these and other devices on network 10 may be via Ethernet, phone line, and/or wireless link, for example. Network 10 may include a local portion 19 comprised of base computer system 12 and IGS 14 and an external portion 20 comprised of geo-servers 15, 16, 17. The local portion may be a local area network (LAN) running a protocol such as RFP, and the external portion may be a wide area network (WAN) and/or the Internet running a protocol such as HTTP (HyperText Transfer Protocol). It is noted that devices depicted on the local portion may be on the external portion and vice versa.

Geo-servers 15, 16, 17 are used by various geographic services, such as the ESRI ArcIMS and PTV eMapServer, to provide output geographic information to IGS 14 in response to input geographic information received from IGS 14. Generally speaking, the term “geocoding” refers to converting input geographic information, such as addresses, into output geographic coordinates. Geographic services, however, also provide other features, such as route planning and distance calculation. These features enable users to plan routes and determine distances between specified locations. Geographic services also provide road maps, as described below.

Thus, the input or output geographic information referred to above may include geographic coordinates (e.g., a longitude and latitude) of an address. The input or output geographic information may include a street address, a city, a country, and the like. The output geographic information may also include, e.g., routes, such as streets, between two locations, travel time between those locations, and map(s) showing the locations, and the like. Geographic information other than that described here may also be used for input or output.

IGS 14 has a server architecture in which data from base computer system 12 and/or other source(s) can be used to generate graphical or non-graphical output. IGS 14 can be used to encapsulate geographic services' functionality. To this end, IGS 14 provides, to the base computer system or other source(s), geographic services including, but not limited to, sending and receiving requests for displaying maps, routes, planning, coordinates, and addresses.

Base computer system 12 runs one or more software applications, which may provide inputs to IGS 14. Among these applications is transportation planning application 22. Transportation planning application 22 contains various features relating to supply chain management. Supply chain management refers, generally, to managing commerce (e.g., product shipments) between a manufacturer, various intermediaries, such as distribution centers, wholesalers and the like, and customers. Transportation planning application 22 may be used to determine routes for transporting goods along the supply chain, among other things. Transportation planning application 22 generates one or more graphical user interfaces (not shown) that include one or more fields for entering geographic (and other) information that can be provided to IGS 14.

In this embodiment, IGS 14 is a dedicated computer or other processing device that contains memory 24 and one or more processors 25 that run software (executable instructions) 26 stored in memory 24 to provide the functionality described herein (see view 27, which depicts the architecture of IGS 14). It should be noted, however, that the IGS is not limited to this architecture and, instead, can include any combination of hardware and/or software, as noted below.

Software 26 may include, but is not limited to, network software 29 for communicating over network 10, operating system software 30, and operational software 31 for transmitting information between geo-servers 15, 16, 17 and base computer system 12. Operational software 31 may include various modules that convert data between formats for transmission to applications running on base computer system 12 and from such applications to a geo-server.

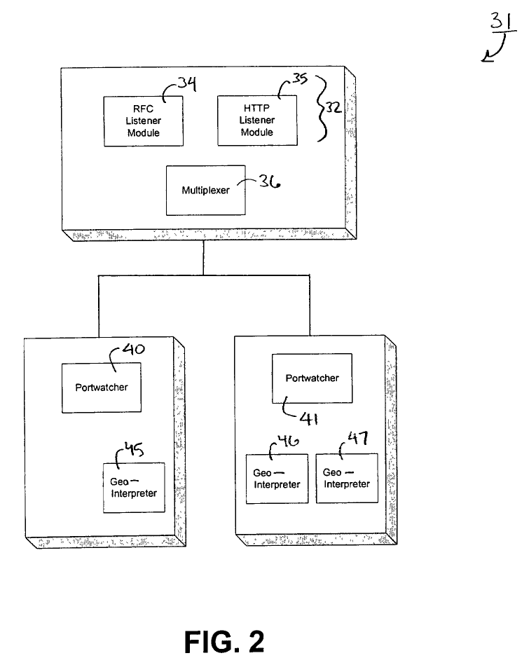

FIG. 2 shows the architecture of operational software 31 in one embodiment of IGS 14. Operational software 31 includes communication modules 32. Communication modules 32 include RFC listener module 34 and HTTP listener module 35. RFC listener module 34 and HTTP listener module 35 “listen” for communications from network 10, e.g., to pick-up communications from base computer system 12.

More specifically, communication modules 32 receive data from network 10, filter the data to detect IGS-destined communications, convert the data from the RFC or HTTP format to an IGS-internal data format, and provide the resulting converted data to multiplexer 36. Communication modules 32 also output data from IGS 14 (to, e.g., base computer system 12) onto network 10, in the process performing any necessary conversions to RFC or HTTP format.

Multiplexer 36 is the central instance for data communications between communication modules 32 and portwatchers 39, 40, 41 (described below). Multiplexer 36 sends data packets from a communication module, via a portwatcher, to an interpreter (described below). Multiplexer 36 “knows” which interpreters are available and therefore can assign the data packets based on the number of available interpreters in order to balance the load of each interpreter.

Multiplexer 36 can also turn interpreters on and off via a portwatcher. As a result, multiplexer 36 can perform active load balancing. That is, if the number of data packets exceeds a predetermined limit, then multiplexer 36 can turn on an interpreter and thereby lessen the number of data packets that each of the other interpreters must process. In this embodiment, there is one multiplexer for IGS 14; however, any number of multiplexers can be used.

A portwatcher is a software module that instantiates the components (e.g., the interpreters) configured for the portwatcher, registers with multiplexer 36, and informs multiplexer 36 of the interpreters that are available.

Each portwatcher communicates with multiplexer 36 using, e.g., a socket interface or a shared memory if the multiplexers and portwatchers use the same hardware. A portwatcher receives its “requests” (e.g., to obtain geocoordinates and/or a map) from multiplexer 36 and can return its status if requested by multiplexer 36. Requests that portwatchers receive from multiplexer 36 are sent by the portwatchers to the appropriate interpreters. A portwatcher may service one or more software modules (e.g., interpreters, engines, etc.). These software modules carry-out the requests and send results back to multiplexer 36 via the portwatchers.

Software modules 45, 46, 47, which are C++ applet “plug-ins” in this embodiment, are installed on IGS 14. Alternatively, JAVA plug-ins may be used.

IGS Geographic Services

Referring to FIGS. 1 and 2, geo-interpreters 45, 46, 47 correspond to respective geo-servers 15, 16, 17. Each geo-interpreter is designed to communicate with its corresponding geo-server. Multiple geo-interpreters may communicate with the same geo-server and/or a single geo-interpreter may communicate with multiple geo-servers.

Each geo-server 15, 16, 17 is capable of recognizing data having a specific format. Data that is not formatted properly, in general, cannot be processed by the geo-server and/or may not be processed properly. Geo-interpreters 45, 46, 47 perform data formatting for their respective geo-servers 15, 16, 17. For example, in a case that geo-interpreter 45 is written for geo-server 15, geo-interpreter 45 generates data that is in a format that geo-server 15 understands. In a case that geo-interpreter 46 is written for geo-server 16, geo-interpreter 46 generates data that is in a format that geo-server 16 understands, and so on.

Each geo-server also has a specific access protocol. The geo-interpreters are therefore also configured to provide the correct access protocol for their corresponding geo-servers.

Any number of geo-interpreters may be installed per IGS, thereby permitting connection to any number of different geo-servers. Interpreters may also be included in IGS 14 to connect to other geographic information systems, such as map databases and the like.

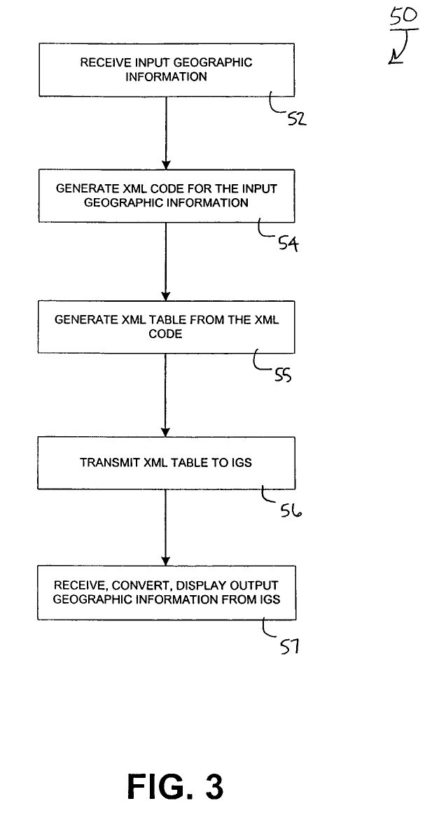

FIG. 3 shows a process 50 to provide geographic services from IGS 14 to transportation planning application 22. Transportation planning application 22 receives (52) input geographic information from one or more GUIs (not shown). Transportation planning application 22 passes the input geographic information to a lower-level software application 23 on base computer system 12. Lower-level software application 23 generates (54) standard eXtensible Markup Language (XML) code that defines the address information and passes that XML code to a geocoding framework application 28 within lower-level application 23.

Geocoding framework application 28 generates (55) a table from the XML code and passes that table back to transportation planning application 22. Geocoding framework application 28 generates the table by extracting XML fields from the XML code and inserting the former XML fields into the table. In this embodiment, the table is a look-up table (LUT) containing rows that include the XML code; however, other types of tabular and non-tabular formats may be used. Transportation planning application 22 transmits (56) the table containing XML code to IGS 14 via network 10 using a protocol such as HTTP or RFC.

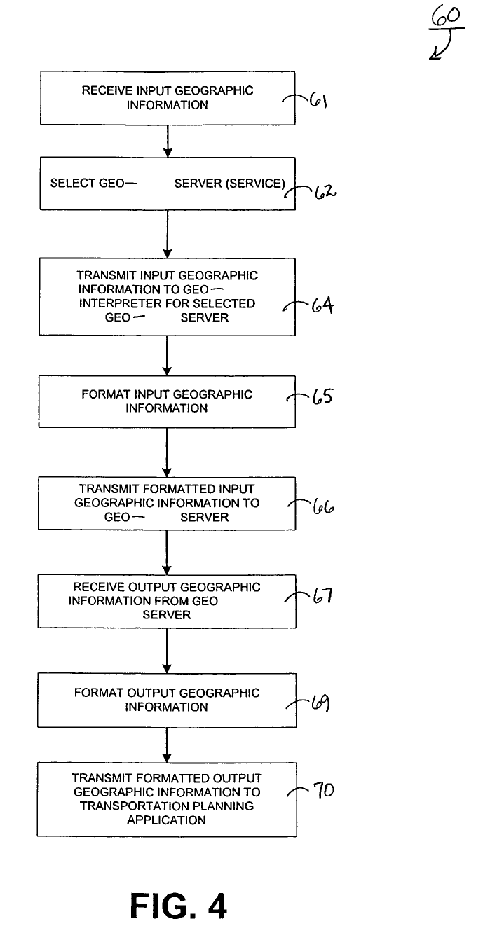

FIG. 4 shows a process 60, which is performed by software in IGS 14 for obtaining geographic information from one (or more) of geo-servers 15, 16, 17. Process 60 receives (61) input geographic information from transportation planning application 22. As noted above, the input geographic information is formatted as a table containing XML code.

Process 60 selects (62) a geo-server from which to obtain output geographic information that corresponds to the input geographic information. Process 60 may select the geo-server based on one or more factors. For example, the input geographic information may include an indication of which geo-server to select. A user running transportation planning application 22 may input the indication of which geo-server to select or IGS 14 or transportation planning application 22 may select a geo-server automatically based on input geographic information (or some other criteria). Alternatively, multiplexer 36 (FIG. 2) may select the geo-server, e.g., by performing load balancing, as described above.

By way of example, one geo-server 15 may provide more accurate information for a particular country, such as Germany, than another geo-server 16. Accordingly, IGS 14 may contain a rule whereby each time a user indicates an address in Germany, IGS 14 automatically selects geo-server 15. The same process may be applied for other fields as well. For example, one geo-server may provide more accurate information for a particular continent (e.g., Europe), area of a city, country, or for a particular mode of transportation. For example, one geo-server may provide more accurate information for roadways and another geo-server may provide more accurate information for railways.

In other instances, the desired geographic information may not be available from one geographic service, but may be available from another geographic service. If IGS 14 knows beforehand which geographic services provide which information, IGS 14 can direct geographic requests accordingly. If IGS 14 does not know the types of information available from the various geographic services, IGS 14 can request the information from more than one geographic service. For example, IGS 14 can output a request to multiple geo-servers concurrently, or try each geo-server sequentially until IGS 14 obtains the requested information.

Process 60 transmits (64) the input geographic information to an interpreter that corresponds to the selected geo-server. For example, if ESRI is selected as the geo-server, process 60 transmits the input geographic information to the interpreter that is designed to work with ESRI. As noted above, this transmission may be performed via multiplexer 36 and a portwatcher.

The interpreter receives the input geographic information and formats (65) the input geographic information (i.e., the generic XML-tabular format described above) so that it is compatible with the selected geo-server. That is, the interpreter converts the data so that the format of the input geographic information is compatible with the data format of the selected geo-server. In the example described above, if the ESRI interpreter is selected, the interpreter converts the generic XML tabular data to the data format that is recognized by ESRI. The same process is true for interpreters for other geocoding services. Thus, IGS 14 provides a generic interface to multiple geocoding services.

Process 60 transmits (66) the reformatted input geographic information from the interpreter to the selected geocoding service, together with any instructions, such as the type of data requested from the geocoding service. Transmission may be over a network, such as the Internet or the like. Since the data is in the format that is recognized by the geocoding service, the geocoding service can process the data and provide the requested output geographic information. For example, if the input geographic information is geographic coordinates, the output geographic information provided by the geo-server may be specific addresses that correspond to the input geographic coordinates.

The geo-server transmits its output (the output geographic information) back to IGS 14. The appropriate communication module, e.g., RFC listener module 34 or HTTP listener module 35, receives (67) the transmission and, via multiplexer 36 and a portwatcher, provides the output geographic information to the appropriate interpreter. For example, if ESRI provides the output geographic information, the output geographic information is provided to the geo-interpreter (e.g., geo-interpreter 17) that is used to communicate with the ESRI server.

Geo-interpreter 17 formats (69) the output geographic information so that a format of the output geographic information is compatible with a device that provided the input geographic information. In this embodiment, the interpreter converts the geographic information received from the geo-server from the format that is recognizable by the geocoding service to the XML-tabular format described above. Other conversions, however, may be performed.

Interpreter 17 transmits (70) the output geocoding information in XML-tabular format back to transportation planning application 22. Transmission may be via a network, such as the Internet. Referring to FIG. 3, transportation planning application 22 receives (57) the output geocoding information from interpreter 17, performs any necessary conversions on the output geocoding information, and displays the results in a GUI (not shown).

Different types of geocoding functions may be available through IGS 14 depending on the capabilities of the various geo-servers. These functions may be provided by sending the necessary instructions to a geo-server, obtaining the information from the geo-server, and sending that information back to the transportation planning application in the manner described above. In some cases, which are specified below, IGS 14 may perform some additional processing on data received from a geo-server before sending the data back to the transportation planning application.

The IGS “routing” function obtains the route, distance and drive time between a start location and an end (target) location. IGS 14 provides the start and end locations (e.g., addresses, geographic coordinates, etc.) to a geo-server, which replies with the route, distance and drive time between the start and end locations. In addition, a user may define a sequence of stop-over locations (i.e., scheduled stops) that have to be passed on the way from the start location to the end location. The effects of these stop-over locations on the overall route, distance and drive time are taken into account by the geocoding service when determining the route, distance and drive time. The start and end locations may be defined in terms of their geographic coordinates, as described above.

The “average speed” function determines the expected average speed along a specified route. This information is provided by a geo-server once a route between two locations is specified, and can take into account the type of roadway along the route. For example, the average speed function may take into account whether a roadway is a highway, freeway, city road, etc. The geocoding service uses the expected average speed, along with the route's distance, to determine the expected travel time along the route.

The “route determination” function is performed in the geo-server. The routes are determined based on the geocoordinates of the start location, the target location, and, if provided, any stop-over locations. In addition criteria like the shortest route or the fastest route can be taken into account. The drive time is calculated based on the route and the given average speed. The result is sent back from the geo-server to the IGS.

The information is then provided from IGS 14 to the transportation planning application, as noted above.

The “distance and duration matrix” function is performed by the geo-server after the request is sent from the IGS to the geo-server. This function determines a matrix of distances and durations between various locations based on the geocoordinates of a given set of locations obtained from one or more geographic (e.g., geocoding) services.

The “map display” function generates a map for a given area defined by two geocoordinates. The two geocoordinates, which define opposite (diagonal) corners of the map, are provided to a geo-server. The geo-server replies with the requested map. The map can have different levels of detail. The level of detail depends on the geocoding service(s) used to obtain information for the map.

Several additional functions may be provided through IGS 14 that can affect the way a map is displayed. These functions may be implemented through a geo-server. The functions include displaying descriptive text, such as names or other information, on the map, displaying objects on the map in different styles, displaying different routes between two points in different colors, and displaying different types of objects in different shapes and colors. Other functions include the ability to zoom-in or zoom-out on a map, and to resize a container (e.g., window) that displays the map.

A map can be provided in different graphic formats, such as bitmap, JPEG, GIF, PNG, etc. The map can be displayed with different layers, e.g., rivers, roads, etc. A legend can be displayed on the map or as a separate picture object showing information such as the scale of the map and the like. Different regions of the map can be colored differently, e.g., to highlight different area code regions (see below). Objects on the map can be selected by a click A path can be generated by drawing a line from one customer to another customer and then performing the necessary calculations to determine the driving route between the two customers.

Displaying Road Maps

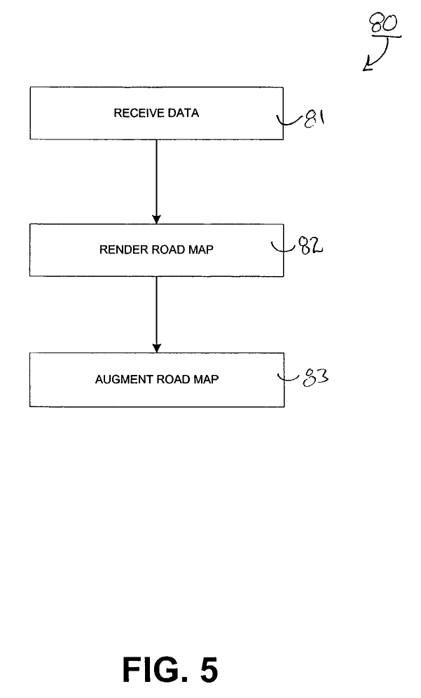

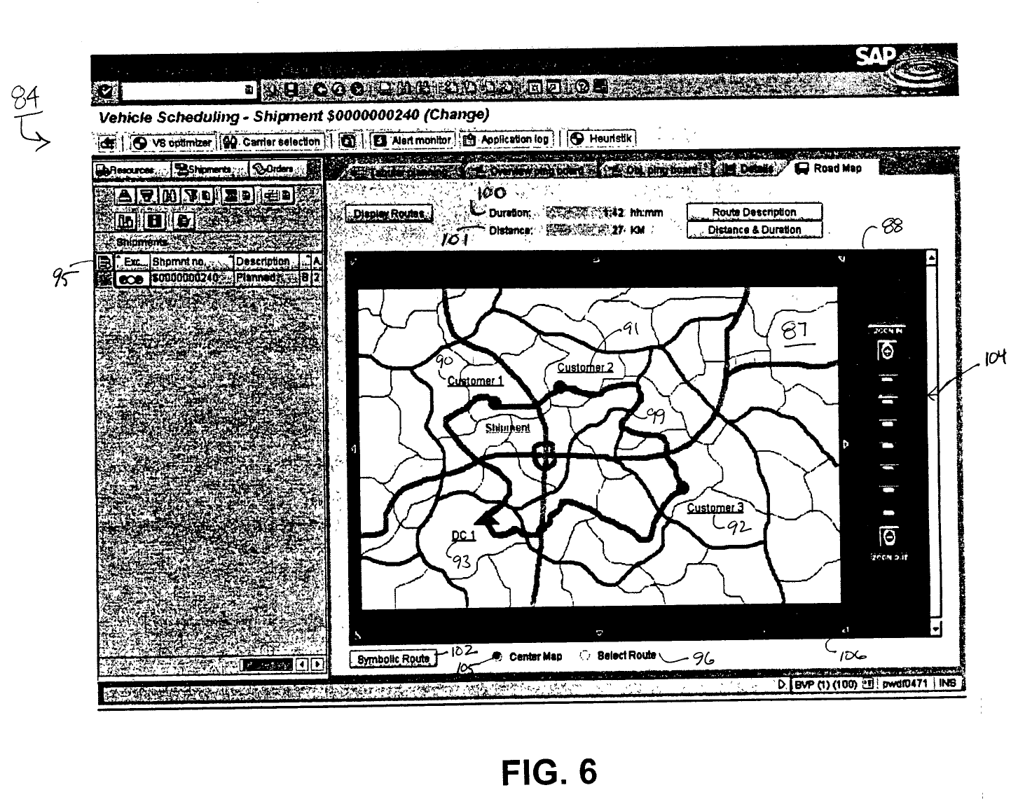

Referring to FIG. 5, a process 80 is shown for displaying road maps within transportation planning application 22. In process 80, transportation planning application 22 receives (81) data for a road map from IGS 14. The data is received in response to a request that is transmitted to IGS 14 in the manner described above. The IGS renders (82) a road map from the data. The road map may be rendered in a GUI 84, such as the GUI shown in FIG. 6.

As shown in FIG. 6, GUI 84 includes a window 88 to display road map 87. Road map 87 itself includes target locations 90 to 93. These target locations correspond to destinations along a route in a supply chain. The destinations may be customer locations, distribution center locations, warehouse locations, and the like. Road map 87 may also include expected “stop-over” locations (not shown) between the target locations. In this context, stop-over locations are scheduled stops on the way to a destination (e.g., a stop at a customer).

Road map 87 may be displayed in a route view (shown) or a symbolic view (not shown). In the route view, road map 87 displays actual roads between the target locations, together with icons or the like to indicate the target locations. Different icons may be displayed for different types of target locations. For example, customers 90, 91, 92 may be displayed using one type of icon and a distribution center (DC1) 93 may be displayed using another type of icon. Stop-overs may be displayed using yet another type of icon. The routes may be displayed using different colors and sizes. The roads are displayed in a format that is generated by the geo-server.

The actual route to be traveled by a vehicle is displayed as an outline of the road(s) to be traveled. The route may be displayed using a distinctive color (e.g., red) or style (bold). Different routes (e.g., alternative roads between two target locations) may be displayed on the same road map using different colors, textures, etc. Similarly, the shortest or quickest route may be displayed using different colors.

The route view shows the exact route to drive between two locations. The route contains all segments between two locations. If the symbolic route view is selected, the segments and parts are neglected and the route object contains only the stop, target and stop-over locations. In this regard, a segment of a route is the way between two following waypoints, which are passed from one location to another, e.g., a segment is the way from a certain exit of a road to a next exit. A waypoint is a significant point on a route. The waypoints of a route may include points that are passed to drive from the start to the target location of a route. A waypoint can be a point where a certain direction has to be taken (crossing, etc.) or any other point that defines describes the route to drive.

After selecting one route on the map, the transportation planning application calls an event-handler routine, which identifies the route. For this selected route, information at its segment level is listed in an additional pop-up window showing the route's distance, duration and description.

For all routes, distance and duration information is displayed in an additional window. The event-handler routine reacts if a route is selected. If a route is selected, the route's object is identified. Then, the route's distance and duration is determined and displayed above the map. After pressing a button identifying the route's description, the description is displayed in a pop-up window.

As described above, the actual route to be traveled may be determined by a geo-server and provided to transportation planning application 22 via IGS 14. IGS 14 may provide the map of the route. IGS 14 renders the map to show the route.

In the symbolic view, roads may still be displayed on the road map; however, the routes are displayed as straight lines between target locations (rather than as an outline of roads to be traveled). The straight lines may be displayed in any color or style to differentiate the lines from the roads. IGS 14 provides the routes and the map (e.g., from a geo-server). IGS 14 renders the map and transportation planning application 22 determines the straight lines (segments) in the symbolic view. Alternatively, IGS 14 may determine the straight lines and provide the straight lines to IGS 14, together with information indicating where they are to go.

The geo-server can generate and place landmark icons on the map. These landmark icons can be augmented by IGS 14. Landmark icons indicate the location of landmarks on the map, usually along or near to a route specified between target locations. In this context, a landmark is any point of interest. Examples of landmarks include, but are not limited to, gas stations, restaurants, construction zones, sights, and buildings. Each landmark may be illustrated using a distinctive icon. For example, a “pump” may be used to show a gas station, a yellow triangle may be used to show construction, etc.

Referring back to FIG. 6, GUI 84 contains various features for altering the appearance and content of road map 87. Shipment list 95 provides a list of shipments scheduled for delivery via transportation planning application 22. Each shipment is linked to a corresponding road map. The road map shows the route that a vehicle will take to deliver the shipment. Clicking on a shipment in the shipment list causes transportation planning application 22 to display the road map that corresponds to that shipment in window 88.

The route for a particular shipment may be obtained from a geocoding service via IGS 14 in the manner described above. That is, the data for each shipment contains target locations, which are provided to IGS 14, along with a request for a road map containing a route between the target locations.

Information pertaining to shipments along a selected route may be displayed in a “pop-up” window (not shown). A user may obtain this information by clicking on “select route” button 96 and then selecting a route on road map 87. The information pertaining to a selected route may include, e.g., distances, durations, and descriptive text associated with segments along a selected route. In this context, a “segment” of a route constitutes the path (e.g., path 99) between two locations along a route. The information displayed in the pop-up window may also relate to a shipment being transmitted along that route, e.g., the contents of the shipment, delivery schedules, and the like.

Shipments can be organized by vehicle or by order. That is, a shipment can constitute an order or the contents of an entire vehicle. Thus, shipment of individual orders or the contents of an entire vehicle (which may contain multiple orders) can be planned and tracked using transportation planning application 22. In this context, an “order” is a request for delivery of one or more products.

Along with the display of road map 87, GUI 84 displays field 100 containing the expected travel time to complete a selected route and field 101 containing the distance along the route. The distance may be displayed in user-specified units, such as miles or kilometers. GUI 84 also contains toggle button 102. Toggle button 102 “toggles” the display of road map 87 between the route view and the symbolic view described above.

Controls 104 allow a user to zoom-in or to zoom-out on road map 87. Road map 87 can be shifted within display window 88. That is, clicking on center map button 105 and clicking on a point in road map 87 will orient road map 87 so that the point clicked becomes the center of the map. Navigation arrows 106 allow a user to scroll over road map 87.

Layers of road map 87 can be displayed using a control button (not shown) on GUI 84. That is, a user can configure road map 87 so that only roadways are displayed and then add (or later subtract) “layers” of detail, such as street names, buildings, geographic features (rivers, mountains, etc.), points of interest and the like.

Other Embodiments

FIG. 1 shows computers for implementing processes 50, 60 and 80. Although computers are shown, processes 50, 60 and 80 are not limited to use with the hardware and software of FIG. 1. They may find applicability in any computing or processing environment. Processes 50, 60 and 80 may be implemented in hardware, software, or a combination of the two.

Processes 50, 60 and 80 may be implemented in computer programs executing on one or more programmable computers or other machines that each include a processor and a storage medium readable by the processor (including volatile and non-volatile memory and/or storage components).

Each such program may be implemented in a high-level procedural or object-oriented programming language to communicate with a computer system. However, the programs can be implemented in assembly or machine language. The language may be a compiled or an interpreted language.

Each computer program may be stored on a storage medium or other article of manufacture (e.g., CD-ROM, hard disk, or magnetic diskette) that is readable by a general or special purpose programmable computer for configuring and operating the computer when the storage medium or device is read by the computer to perform processes 50, 60 and 80. Processes 50, 60 and 80 may also be implemented as a machine-readable storage medium, configured with computer program(s), where, upon execution, instructions in the computer program(s) cause a machine to operate in accordance with processes 50, 60 and 80.

The inventions are not limited to the embodiments described above. For example, IGS 14 is not limited to use with the geocoding services mentioned herein. Any geocoding service may be used with IGS 14. Maps may be displayed in transportation planning application 22 without using IGS 14. That is, transportation planning application 22 may interact directly with a geocoding service (server) in order to obtain the information needed to display GUI 84.

Other embodiments not described herein are also within the scope of the following claims.

What is claimed is:

1. A method of displaying a road map in a transportation planning computer program, the method comprising:
receiving data for the road map;
rendering the road map from the data;
augmenting the road map with landmark information; and
toggling between a route view of the road map and a symbolic view of the road map, the route view comprising a driving route between two locations on the road map, and the symbolic view comprising straight lines between locations on the road map.

2. The method of claim 1, wherein rendering the road map includes rendering target locations and expected stop-over locations between the target locations.

3. The method of claim 2, wherein rendering the road map includes rendering customer locations as the target locations.

4. The method of claim 1, wherein augmenting the road map with landmark information includes augmenting the road map with points of interest along a route between two or more target locations.

5. The method of claim 4, wherein augmenting the road map with landmark information includes augmenting the road map with one or more of a gas station along the route, a location of a restaurant along the route, and a location of construction along the route.

6. The method of claim 1, further comprising:
displaying at least one of distance and travel time for a selected route on the road map.

7. The method of claim 1, further comprising:
selecting a shipment associated with the transportation planning computer program; and
requesting data for a road map associated with the selected shipment;
wherein the data received for the road map comprises data associated with the selected shipment.

8. The method of claim 1, further comprising:
requesting the data from a geocoding service; and
receiving the data from the geocoding service.

9. The method of claim 8, further comprising routing the data via a server that provides a generic interface to servers associated with plural geocoding services.

10. A graphical user interface (GUI) for a transportation planning computer program, comprising:
a window to display a road map that defines target locations, a route between the target locations, and a landmark along the route; and
a list of shipment options, at least one of the shipment options corresponding to the road map.

11. The GUI of claim 10, further comprising:
a first field to display a travel time between the target locations; and
a second field to display a distance between the target locations.

12. The GUI of claim 10, further comprising:
a button for toggling between a route view of the road map and a symbolic view of the road map, the route view comprising a driving route between two locations on the road map, and the symbolic view comprising straight lines between locations on the road map.

13. The GUI of claim 10, further comprising:
a control to zoom-in and zoom-out on the road map.

14. A machine-readable medium that stores executable instructions for displaying a road map, the instructions, when executed, causing a machine to:
receive data for the road map;
render the road map from the data;
augment the road map with landmark information; and
toggle between a route view of the road map and a symbolic view of the road map, the route view comprising a driving route between two locations on the road map, and the symbolic view comprising straight lines between locations on the road map.

15. The machine-readable medium of claim 14, wherein the road map includes target locations and expected stop-over locations between the target locations.

16. The machine-readable medium of claim 15, wherein the target locations comprise customer locations.

17. The machine-readable medium of claim 14, wherein the landmark information comprises points of interest along a route between two or more target locations.

18. The machine-readable medium of claim 17, wherein the landmark information comprises one or more of a gas station along the route, a location of a restaurant along the route, and a location of construction along the route.

19. The machine-readable medium of claim 14, further comprising instructions that cause the machine to:
display at least one of distance and travel time for a selected route on the road map.

20. The machine-readable medium of claim 14, further comprising instructions that cause the machine to:
select a shipment associated with the transportation planning computer program; and
request data for a road map associated with the selected shipment;
wherein the data received for the road map comprises data associated with the selected shipment.

21. The machine-readable medium of claim 14, further comprising instructions that cause the machine to:
request the data from a geocoding service; and
receive the data from the geocoding service.

22. The machine-readable medium of claim 21, further comprising instructions that cause the machine to route the data via a server that provides a generic interface to servers associated with plural geocoding services.

23. An apparatus for displaying a road map, the apparatus comprising:
a memory that stores executable instructions; and
a processor that executes the instructions to:
receive data for the road map;
render the road map from the data;
augment the road map with landmark information; and
toggle between a route view of the road map and a symbolic view of the road map, the route view comprising a driving route between two locations on the road map, and the symbolic view comprising straight lines between locations on the road map.

24. The apparatus of claim 23, wherein the road map includes target locations and expected stop-over locations between the target locations.

25. The apparatus of claim 24, wherein the target locations comprise customer locations.

26. The apparatus of claim 23, wherein the landmark information comprises points of interest along a route between two or more target locations.

27. The apparatus of claim 26, wherein the landmark information comprises one or more of a gas station along the route, a location of a restaurant along the route, and a location of construction along the route.

28. The apparatus of claim 23, wherein the processor executes instructions to display at least one of distance and travel time for a selected route on the road map.

29. The apparatus of claim 23, wherein the processor executes instructions to:
select a shipment associated with the transportation planning computer program; and
request data for a road map associated with the selected shipment; and
wherein the data received for the road map comprises data associated with the selected shipment.

30. The apparatus of claim 23, wherein the processor executes instructions to:
request the data from a geocoding service; and
receive the data from the geocoding service.

31. The apparatus of claim 30, wherein the processor executes instructions to route the data via a server that provides a generic interface to servers associated with plural geocoding services.
